(19) United States
(12) Patent Application Publication
(10) Pub. No.: US 2009/0222612 A1
(43) Pub. Date: Sep. 3, 2009

(54) Programmable Food Service Systems

(75) Inventors: Nigel Thorneywork, Surrey (GB); Andrew Brown, Surrey (GB); Robert Finnis, Surrey (GB); David Crayfourd, London (GB)

Correspondence Address: OHLANDT, GREELEY, RUGGIERO & PERLE, LLP, ONE LANDMARK SQUARE, 10TH FLOOR, STAMFORD, CT, 06901, US

(73) Assignee: MERRYCHEF LIMITED, Aldershot (GB)

(21) Appl. No.: 12/225,632

(22) PCT Filed: Mar. 16, 2007
(86) PCT No.: PCT/GB2007/050126

§ 371 Date: May 4, 2009

(30) Foreign Application Priority Data
Mar. 27, 2006 (GB) 0605922.4

(51) Int. Cl. G06F 12/02; G06F 13/00

(52) U.S. Cl. 711/103; 710/304; 711/E12.008

(57) ABSTRACT

A data key, for use with a programmable food service device, comprises: an insertion portion, for insertion into a key aperture in the programmable food service device; a data memory for storing data relating to the operation of the programmable food service device; and a data connection portion for connecting directly with a data port on a computer, to allow the computer to access the data memory.

The invention relates to data keys for use with programmable food service devices, and to food service systems and methods of operating food service systems.

The applicant's earlier international patent applications published under numbers WO 02/23952 and WO 2004/068269 describe programmable cooking systems and programmable food service systems which make use of data keys. These two earlier specifications are incorporated by reference in the present specification in their entirety.

The first four figures of WO 02/23952 are reproduced in the present specification as FIGS. 1 to 4, and these are described below.

FIG. 1 shows a data key (for example Serial Memory Token LCK 16000 manufactured by Datakey, Inc. of 407 West Travellers Trail, Burnsville, Minn. 55337, USA) and a data key reader 2. The reader 2 is provided with a key aperture 2a adapted to receive the key 1 in order to allow data to be passed to and from the key 1. The key 1 is provided with E²PROM (electrically erasable programmable ROM) for storing data, and with a number of electrical contacts 1a for communicating with the reader 2.

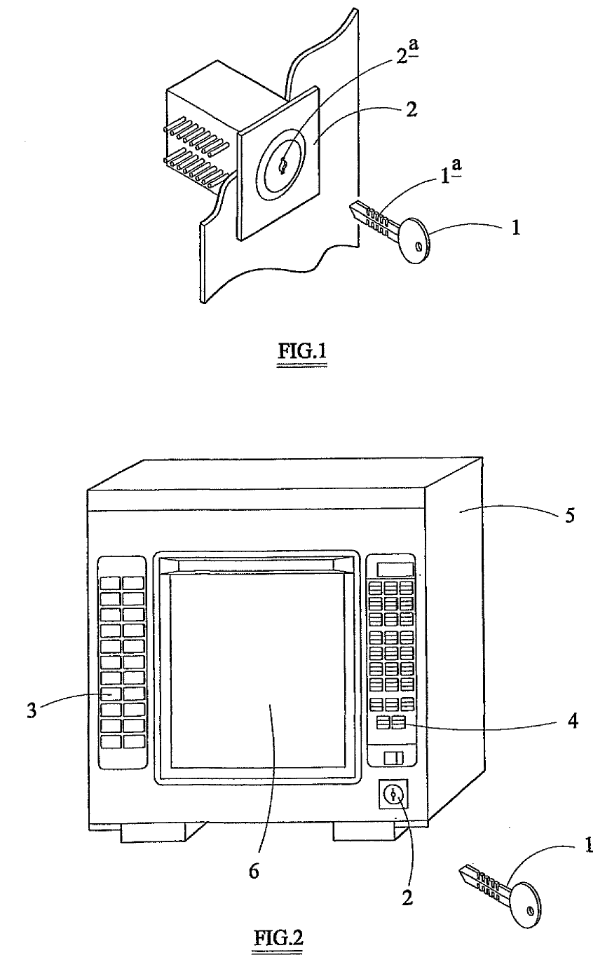

FIG. 2 shows the key reader 2 mounted in the front panel of a microwave combination oven 5 (for example model EV2451 made and sold by Merrychef Ltd). The oven 5 is provided with a manual control panel 4, door 6, and twenty pre-program keys 3 which allow twenty pre-programmed cooking sequences to be called up at the touch of a button.

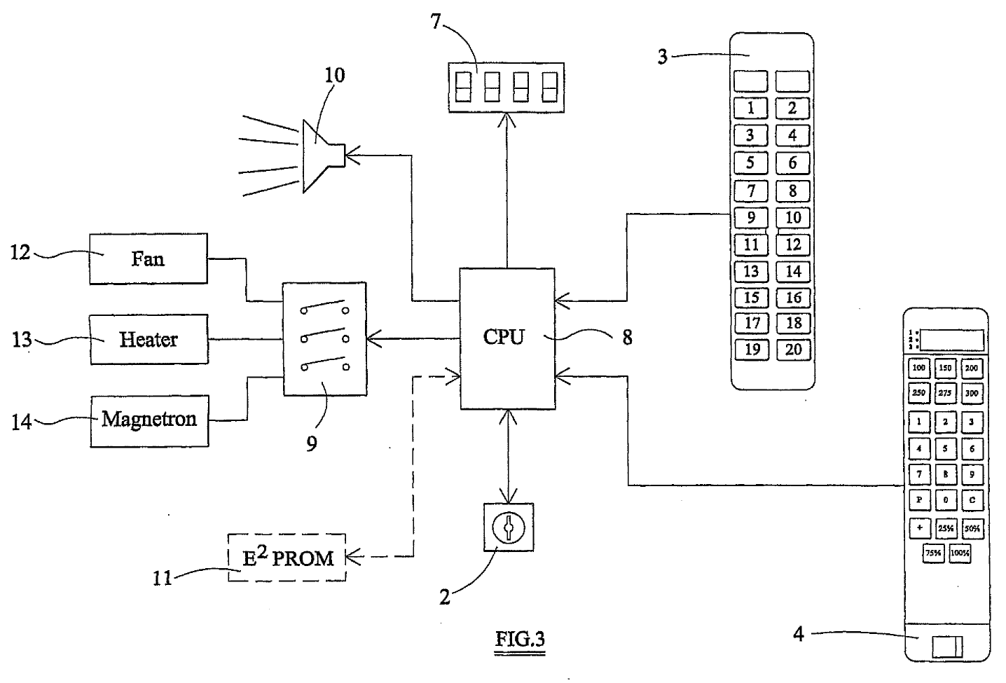

FIG. 3 shows the electronic components of the oven 5, including the key reader 2, pre-program keys 3, manual control panel 4, together with a display 7, CPU (central processing unit) 8, switching unit 9, alarm/beeper 10, E²PROM 11, fan 12, heater 13, and magnetron 14. The E²PROM 11 exchanges data with the data key 1 via the CPU 8 in known manner.

The data key 1 is provided with program data corresponding to different cooking sequences at a data site, and is then sent to the cooking site for use with the oven 5, and with other programmable cooking devices (not shown), each of which is provided with a key reader 2. Although only the oven 5 is described here, the data key 1 operates with each other programmable cooking device in a similar fashion.

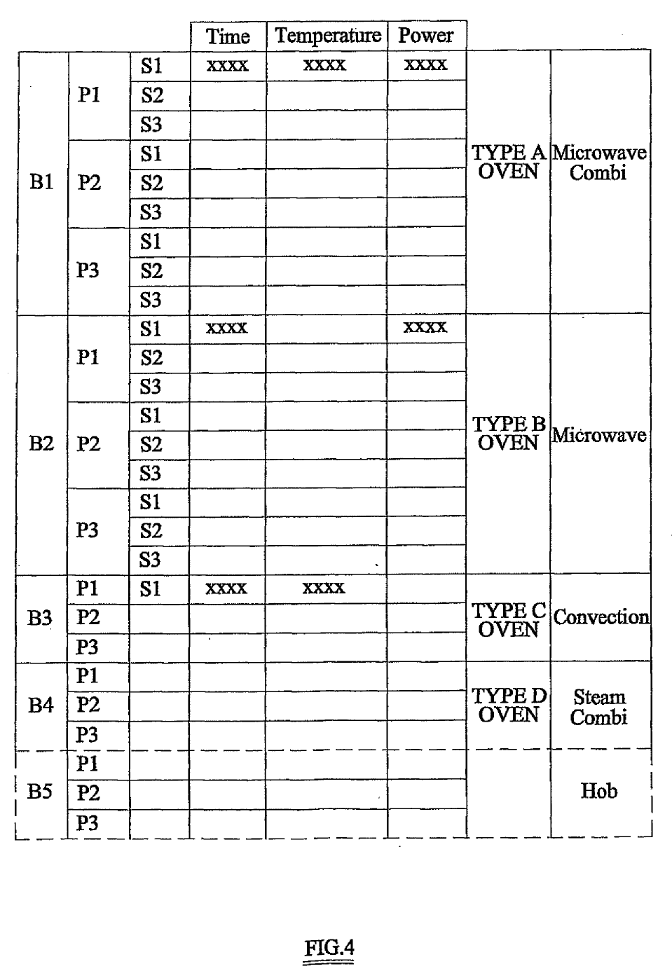

FIG. 4 shows a typical arrangement of the memory of the data key 1. The memory is divided into 5 blocks, B1 to B5, each of which contains data corresponding to the cooking sequences of a different type of cooking device. Thus, in the example the blocks B1 to B5 correspond to a microwave combination oven, a microwave oven, a conventional convection oven, a steam combination oven, and a hob respectively.

In the example of FIG. 4, each block contains three programs, P1 to P3, each containing the data for a different cooking sequence comprising a number of stages S1, S2, S3 etc. Each stage contains data specifying the time, power and temperature (or other controllable features) for that stage of the cooking sequence.

The data key 1 can be inserted into any or all of the available cooking devices in order to update the program data for that cooking device. In the example of FIG. 4 the key 1 works with any cooking device of the type corresponding to a given block of the key memory. However, further embodiments are possible in which different blocks are provided for different cooking devices of the same type. For example, a given cooking site may have a number of microwave ovens of the same type which require different program data.

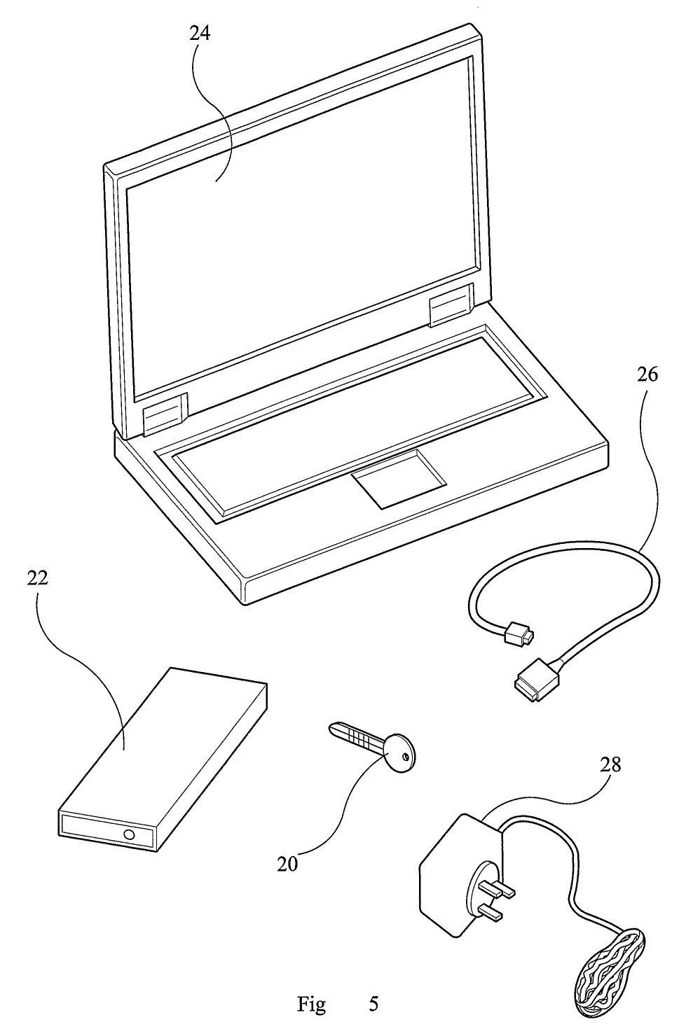

WO 02/23952 then goes on to describe the sequence of operations which are carried out, by reference to the flow-charts shown in FIGS. 5 to 7 of WO 02/23952.

As described in WO 2004/068269, the system is not limited to cooking devices, but can also be used with food service displays, ice makers, ventilation systems and other devices which are involved in the serving of food. Each of these devices may be programmable, and may include a key aperture adapted to receive a data key of the type described above.

In the practical operation of systems of the type described above it is necessary to program the data keys using additional components which will be described below. This can result in the system being cumbersome, complex and expensive to use in the field.

The invention provides a data key, food service system, and method of operating a food service system, as set out in the accompanying claims.

Embodiments of the invention will now be described, by way of example only, with reference to the accompanying drawings, in which:

FIG. 1 shows a known data key and key aperture, as described above;

FIG. 2 shows a known microwave combination oven provided with such a key aperture;

FIG. 3 is a schematic diagram showing the arrangement of components of the microwave combination oven, as described above;

FIG. 4 shows the arrangement of blocks of memory on the data key described above;

FIG. 5 shows components which are used in the programming of a data key in the known systems described above; and

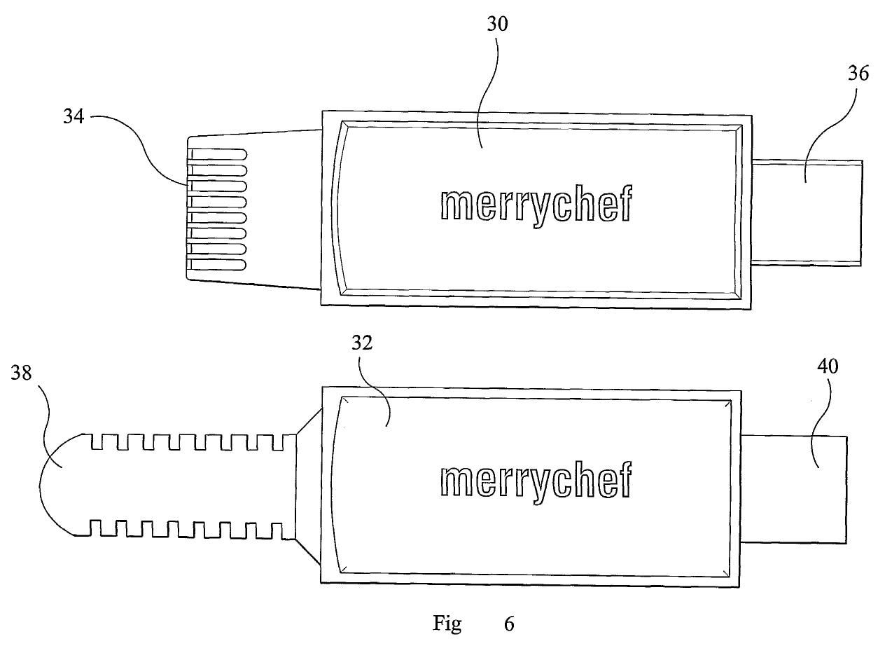

FIG. 6 shows examples of two data keys in accordance with the invention.

FIG. 5 shows components which are used in the programming of a data key 20 in the known systems of WO 02/23952 and WO 2004/068269 described above. In order to program the data key 20, a programmer 22 must be connected to a computer, such as laptop 24, by means of a dedicated lead 26. The lead 26 must be plugged into the programmer 22 at one end, and plugged into the laptop 24 at the other end. In addition, the programmer 22 requires a power supply 28 which must be plugged into a mains power outlet, and also plugged into the programmer 22.

Once the data key 20 has been programmed in the programmer 22, it is then removed from the programmer and can be inserted into the key aperture 2a (see FIG. 1) of a programmable food service device, such as the programmable microwave combination oven 5 shown in FIG. 2. In addition, the process can be reversed, with programs developed on the microwave combination oven 5 (or other food service device) using the control panel 4 being transferred from the data key 20 to the laptop 24 whilst the data key 20 is in the programmer 22.

However, it has been found that when this system is used in the field the need to repeatedly connect the components 22, 26 and 28 is cumbersome, time-consuming, complex, and results in a system which is expensive to produce and maintain.

FIG. 6 shows two data keys 30 and 32 in accordance with the invention. The first data key is provided with an insertion portion 34 at one end, and with a USB (Universal Serial Bus) connector 36 at the other end. The insertion portion 34 is designed to be inserted into a key aperture provided in a programmable food service device, such as the key aperture 2a shown in FIG. 1.

The USB connector 36 is designed to be plugged directly into a USB port on the laptop 24, or other computing device, thus avoiding the need for the programmer 22, lead 26 and power supply 28 described above.

When the USB connector 36 is plugged into a PC or laptop, the data key 30 appears to the computer as a removable drive. Data can then be transferred between the computer and the data key 30.

FIG. 6 also shows a second data key 32, which has a different type of insertion portion 38 at one end, and a USB connector 40 at the other end. The data key 32 functions in the same manner as the data key 30.

As an alternative to the USB connectors 36 and 40, the data keys 30 and 32 may be provided with IEEE 1394 (or FireWire) connectors, or any other connectors suitable for connecting directly with a data port on a laptop, PC or other computer.

1. A data key for use with a programmable food service device, the data key comprising:
an insertion portion, for insertion into a key aperture in said programmable food service device;
a data memory for storing data relating to the operation of said programmable food service device; and
a data connection portion for connecting directly with a data port on a computer, to allow the computer to access said data memory.

2. A data key as claimed in claim 1, wherein said data connection portion is a USB connector for connecting directly with a USB port on said computer.

3. A data key as claimed in claim 1, wherein said data connection portion is an IEEE 1394 connector for connecting directly with an IEEE 1394 port on said computer.

4. A food service system comprising:
a data key for use with a programmable food service device, the data key comprising:
an insertion portion, for insertion into a key aperture in said programmable food service device;
a data memory for storing data relating to the operation of said programmable food service device; and
a data connection portion for connecting directly with a data port on a computer, to allow the computer to access said data memory; and
a programmable food service device comprising:
a key aperture adapted to receive said data key;
a key reader arranged to access the data memory of the data key;
a controller arranged to control the food service device in accordance with data read from the data key by the key reader.

5. A food service system as claimed in claim 4, wherein said food service device is selected from the group comprising: an oven, a fryer, a food service display, an ice maker, a grill, a ventilation system, and any combination thereof.

6. A food service system as claimed in claim 5, wherein said oven is selected from the group consisting of: a conventional oven, a microwave oven, a steam oven and any combination thereof.

7. A food service system as claimed in claim 4, which comprises a plurality of programmable food service devices and/or a plurality of data keys.

8. A food service system as claimed in claim 4, which further comprises a computer having a data port for connecting directly with the data connection portion of the or each data key.

9. A method of operating a food service system comprising at least one programmable food service device, the method comprising:
providing a data key having:
an insertion portion, for insertion into a key aperture in said programmable food service device;
a data memory for storing data relating to the operation of the programmable food service device; and
a data connection portion for connecting directly with a data port on a computer,
connecting said data connection portion of the data key with said data port on the computer, and transferring from the computer to said data memory instructions for operation of the programmable food service device; and
inserting said insertion portion into said key aperture in said programmable food service device, and transferring said instructions from said data memory to the programmable food service device.

10. A method as claimed in claim 9, wherein the data key comprises:
an insertion portion, for insertion into a key aperture in said programmable food service device;
a data memory for storing data relating to the operation of said programmable food service device; and
a data connection portion for connecting directly with a data port on a computer, to allow the computer to access said data memory; and
wherein said data connection portion is a USB connector for connecting directly with a USB port on said computer.

11. A method as claimed in claim 9, wherein the food service system comprises:
a data key for use with a programmable food service device, the data key comprising:
an insertion portion, for insertion into a key aperture in said programmable food service device;
a data memory for storing data relating to the operation of said programmable food service device; and
a data connection portion for connecting directly with a data port on a computer, to allow the computer to access said data memory; and
a programmable food service device comprising:
a key aperture adapted to receive said data key;
a key reader arranged to access the data memory of the data key;
a controller arranged to control the food service device in accordance with data read from the data key by the key reader.
